(19) United States
(12) Patent Application Publication
(10) Pub. No.: US 2026/0233524 A1
(43) Pub. Date: Aug. 13, 2026

(54) LIQUID DISCHARGE HEAD, LIQUID DISCHARGE UNIT, AND LIQUID DISCHARGE APPARATUS

(71) Applicant: Kouichi TAKAHASHI, Kanagawa (JP)

(72) Inventor: Kouichi TAKAHASHI, Kanagawa (JP)

(21) Appl. No.: 19/422,518

(22) Filed: Dec. 17, 2025

(30) Foreign Application Priority Data
Feb. 10, 2025 (JP) 2025-020203

(51) Int. Cl. B41J 2/14; B41J 2/045; B41J 25/00

(52) U.S. Cl. CPC B41J 2/1433; B41J 2/04581; B41J 2/04593; B41J 2/14233; B41J 25/001; B41J 2002/14475

(57) ABSTRACT

A liquid discharge head includes a first actuator unit including a first nozzle substrate and a second actuator unit including a second nozzle substrate. The first nozzle substrate has first nozzles in a first main portion of the first actuator unit and first overlapping nozzles in a first overlapping portion of the first actuator unit other than the first main portion. At least part of the first overlapping nozzles has a first overlapping diameter smaller than the first diameter. The second nozzle substrate has second nozzles in a second main portion of the second actuator unit and second overlapping nozzles in a second overlapping portion of the second actuator unit other than the second main portion. The second overlapping portion is overlapped with the first overlapping portion. At least part of the second overlapping nozzles has a second overlapping diameter larger than the first overlapping diameter.

### CROSS-REFERENCE TO RELATED APPLICATION

This patent application is based on and claims priority pursuant to 35 U.S.C. § 119(a) to Japanese Patent Application No. 2025-020203, filed on Feb. 10, 2025, in the Japan Patent Office, the entire disclosure of which is hereby incorporated by reference herein.

### BACKGROUND

### Technical Field

The present disclosure relates to a liquid discharge head, a liquid discharge unit, and a liquid discharge apparatus.

### Related Art

In the related art, an inkjet-type liquid discharge apparatus includes a liquid discharge head to discharge a liquid from multiple nozzles. The liquid discharge head includes a nozzle substrate on which the multiple nozzles are arrayed, a valve to open and close the nozzle, and an actuator unit having a displacement mechanism to displace the valve between an open position and a closed position of the nozzle.

### SUMMARY

The present disclosure described herein provides an improved liquid discharge head including a first actuator unit and a second actuator unit. The first actuator unit includes a first nozzle substrate arranged in a first direction. The second actuator unit includes a second nozzle substrate arranged in the first direction. The first nozzle substrate has first nozzles and first overlapping nozzles. The first nozzles are disposed in a first main portion of the first actuator unit. Each of the first nozzles has a first diameter. The first overlapping nozzles are disposed in a first overlapping portion of the first actuator unit other than the first main portion. At least part of the first overlapping nozzles has a first overlapping diameter smaller than the first diameter. The second nozzle substrate has second nozzles and second overlapping nozzles. The second nozzles are disposed in a second main portion of the second actuator unit. Each of the second nozzles has a second diameter. The second overlapping nozzles are disposed in a second overlapping portion of the second actuator unit other than the second main portion. The second overlapping portion is overlapped with the first overlapping portion in a second direction orthogonal to the first direction. At least part of the second overlapping nozzles having a second overlapping diameter larger than the first overlapping diameter.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic cross-sectional view of a liquid discharge head;

FIG. 2 is a schematic diagram of actuator units joined (coupled) to each other according to a first embodiment of the present disclosure;

FIG. 3 is a schematic diagram of actuator units joined (coupled) to each other according to a second embodiment of the present disclosure;

FIG. 4 is a schematic diagram of actuator units joined (coupled) to each other according to a third embodiment of the present disclosure;

FIG. 5 is a table illustrating a relationship between a wet spreadability of a recording medium and a nozzle diameter according to a fourth embodiment of the present disclosure;

FIG. 6A is a schematic diagram illustrating an end airflow generated at an end of one actuator unit according to a fifth embodiment of the present disclosure;

FIG. 6B is a schematic diagram illustrating an end airflow generated at an opposite end of the other actuator unit according to the fifth embodiment of the present disclosure;

FIG. 6C is a schematic diagram illustrating an end airflow generated in a coupling portion of the actuator units according to the fifth embodiment of the present disclosure;

FIG. 7 is a table illustrating a relationship between a conveyance speed of a recording medium and a nozzle diameter according to the fifth embodiment of the present disclosure;

FIG. 8 is a schematic front view of a liquid discharge apparatus including a liquid discharge head;

FIG. 9 is a schematic plan view of a liquid discharge unit of the liquid discharge apparatus of FIG. 8;

FIG. 10 is a schematic plan view of a liquid discharge apparatus including a liquid discharge head;

FIG. 11 is a schematic side view of the liquid discharge apparatus of FIG. 10;

FIG. 12 is a schematic plan view of a liquid discharge unit of a liquid discharge apparatus including a liquid discharge head;

FIG. 13 is a schematic front view of another liquid discharge unit of a liquid discharge apparatus including a liquid discharge head; and

FIG. 14 is a schematic front view of an electrode manufacturing apparatus as a liquid discharge apparatus including a liquid discharge head.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

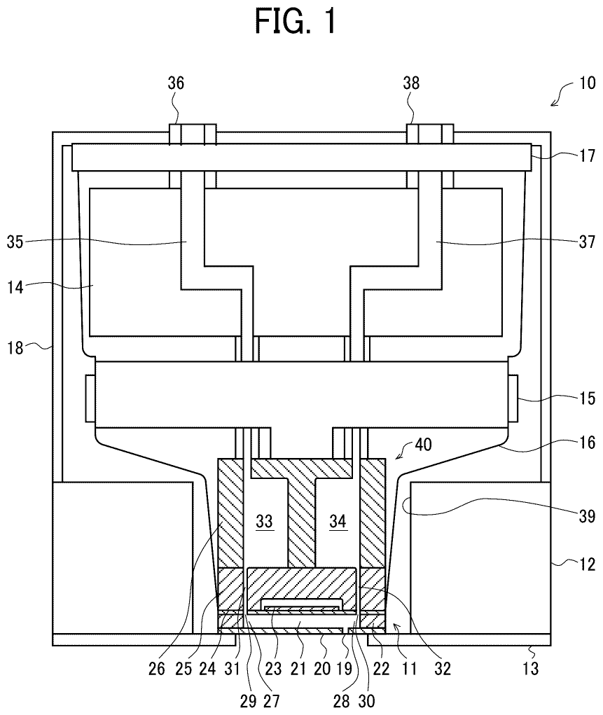

FIG. 1 is a schematic cross-sectional view of a liquid discharge unit 10 in a transverse direction of a liquid discharge head. In FIG. 1, the liquid discharge unit 10 includes multiple liquid discharge heads 11 that discharge a liquid, a base 12 that holds the multiple liquid discharge heads 11, and a cover 13 serving as a nozzle cover that covers nozzles of the multiple liquid discharge heads 11. The liquid discharge unit 10 further includes a manifold 14 defining channels to supply the liquid to the multiple liquid discharge heads 11, a printed circuit board (PCB) 17 connected to a flexible wiring 16 including a driver integrated circuit (IC) 15, and a module case 18.

Each of the multiple liquid discharge heads 11 includes a nozzle substrate 20, a channel substrate 22, a diaphragm 24, a piezoelectric element holding substrate 25, and a frame 26 as a common channel substrate. Nozzles 19 are formed in the nozzle substrate 20. The channel substrate 22 defines individual chambers 21 serving as pressure chambers communicating with the nozzles 19, respectively. The diaphragm 24 includes piezoelectric elements 23. The piezoelectric element holding substrate 25 is laminated over the diaphragm 24. The frame 26 is laminated over the piezoelectric element holding substrate 25.

A material for the nozzle substrate 20 is a single-crystal silicon wafer. In addition to the individual chambers 21, the channel substrate 22 defines supply-side individual channels 27 communicating with the individual chambers 21 and collection-side individual channels 28 communicating with the individual chambers 21, respectively.

A material for the piezoelectric element holding substrate 25 is a single-crystal silicon wafer. The piezoelectric element holding substrate 25 defines supply-side intermediate individual channels 31 and collection-side intermediate individual channels 32. The supply-side intermediate individual channels 31 communicate with the supply-side individual channels 27 via openings 29 of the diaphragm 24. The collection-side intermediate individual channels 32 communicate with the collection-side individual channels 28 via openings 30 of the diaphragm 24.

The piezoelectric element holding substrate 25 and the frame 26 define a supply-side common channel 33 and a collection-side common channel 34. The supply-side common channel 33 communicates with the supply-side intermediate individual channels 31. The collection-side common channel 34 communicates with the collection-side intermediate individual channels 32.

The supply-side common channel 33 communicates with a supply port 36 via a channel 35 of the manifold 14, and the collection-side common channel 34 communicates with a collection port 38 via a channel 37 of the manifold 14. The PCB 17 and the piezoelectric elements 23 are connected to each other via the flexible wiring 16, and the driver IC 15 is mounted on the flexible wiring 16.

In FIG. 1, components hatched with diagonal lines, such as the nozzle substrate 20, the channel substrate 22, the piezoelectric element 23, and an actuator, construct an actuator unit 40.

The multiple liquid discharge heads 11 are mounted on the base 12 at predetermined intervals. The liquid discharge head 11 is inserted into an opening 39 in the base 12, and the peripheral end of the nozzle substrate 20 of the liquid discharge head 11 is bonded and fixed to the cover 13, which is bonded and fixed to the base 12, to attach the liquid discharge head 11 to the base 12.

A flange disposed outside the frame 26 of the liquid discharge head 11 is bonded and fixed to the base 12. A structure for fixing the liquid discharge head 11 to the base 12 is not limited to the above-described structure. The liquid discharge head 11 may be fixed to the base 12 by, for example, bonding, swaging, riveting, or screwing.

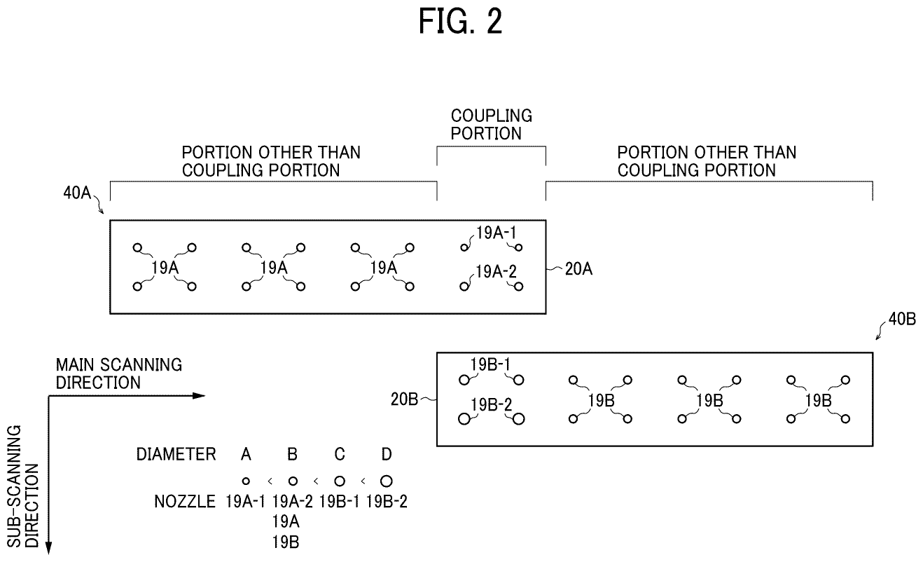

FIG. 2 illustrates nozzle substrates 20A and 20B of the two actuator units 40 (actuator units 40A and 40B), which construct the liquid discharge head 11 according to a first embodiment of the present disclosure. The actuator unit 40A as a first actuator unit has substantially the same configuration as the actuator unit 40 described with reference to FIG. 1, and includes the nozzle substrate 20A as a first nozzle substrate on the bottom face. The actuator unit 40B as a second actuator unit has substantially the same configuration as the actuator unit 40 described with reference to FIG. 1, and includes the nozzle substrate 20B as a second nozzle substrate on the bottom face.

The actuator unit 40A and the actuator unit 40B are coupled to each other in the main scanning direction illustrated in FIG. 2, to form a line image on a wide recording medium. The recording medium is conveyed in the sub-scanning direction illustrated in FIG. 2, and ink as a liquid is discharged from the actuator unit 40A to the recording medium being conveyed, and then the ink is discharged from the actuator unit 40B. In FIG. 2, a portion where the respective actuator units 40A and 40B overlap each other is defined as a coupling portion.

In other word, the nozzle substrate 20A is arranged in a first direction (the main scanning direction in FIG. 2), and the nozzle substrate 20B is arranged in the first direction. The coupling portion of the actuator unit 40A is overlapped with the coupling portion of the actuator unit 40B in a second direction (the sub-scanning direction in FIG. 2) orthogonal to the first direction. The coupling portion may be referred to as an overlapping portion.

Multiple nozzles, such as nozzles 19A, nozzles 19A-1, and nozzles 19A-2, are formed in the nozzle substrate 20A. The nozzles 19A-1 as first coupling nozzles (i.e., a part of first overlapping nozzles) are formed in the coupling portion. The nozzles 19A-1 have a diameter A smaller than a diameter B of the nozzles 19A as first nozzles formed in a portion (i.e., a first main portion) other than the coupling portion. The nozzles 19A-2 as first coupling nozzles (i.e., another part of the first overlapping nozzles) formed in the coupling portion (i.e., a first overlapping portion) have the same diameter B as the nozzles 19A.

Multiple nozzles, such as nozzles 19B, nozzles 19B-1, and nozzles 19B-2, are formed in the nozzle substrate 20B. The nozzles 19B-1 as second coupling nozzles (i.e., a part of second overlapping nozzles) are formed in the coupling portion (i.e., a second overlapping portion). The nozzles 19B-1 have a diameter C larger than the diameter B of the nozzles 19B as second nozzles formed in a portion (i.e., a second main portion) other than the coupling portion. The nozzles 19B-2 as second coupling nozzles (i.e., another part of the second overlapping nozzles) formed in the coupling portion have a diameter D larger than the diameter C of the nozzles 19B-1. The nozzles 19B as second nozzles formed in the portion other than the coupling portion have the same diameter B as the nozzles 19A.

In the portions other than the coupling portion, the actuator unit 40A forms an image by two nozzles 19A arranged in upper and lower arrays in FIG. 2 in the sub-scanning direction, and the actuator unit 40B forms an image by two nozzles 19B arranged in upper and lower arrays in FIG. 2 in the sub-scanning direction. Since the nozzles 19A and the nozzles 19B have the same diameter B, the same discharge amount of liquid droplets can be obtained. Further, since the distance between the nozzles is small, a uniform discharge image can be obtained by changing the voltage of a discharge waveform or adjusting the waveform.

However, when only one of the actuator units is used in the coupling portion, a slight streak may be visually recognized. To solve the above situation to obtain an image having continuity, a discharge voltage in each of the actuator units 40A and 40B may be changed, but a uniform image may not be obtained only by changing the discharge voltage. In addition, when ink is discharged across the actuator units 40A and 40B, the discharge waveform may be adjusted for each nozzle.

To solve the above-described situation, the ink is discharged from the nozzle 19A-1 and then from the nozzle 19B-1 in the coupling portion. In other words, the actuator unit 40A is disposed upstream from the actuator unit 40B in the sub-scanning direction (i.e., a conveyance direction of the recording medium). The ink discharged from the nozzle 19B-1 is superimposed on the ink discharged from the nozzle 19A-1. The diameter C of the nozzle 19B-1 (i.e., at least part of the second coupling nozzles) is larger than the diameter A of the nozzle 19A-1 (i.e., at least part of the first coupling nozzles). In addition, the ink is discharged from the nozzle 19A-2 and then from the nozzle 19B-2 in the coupling portion. The ink discharged from the nozzle 19B-2 is superimposed on the ink discharged from the nozzle 19A-2. The diameter D of the nozzle 19B-2 is larger than the diameter B of the nozzle 19A-2.

With this configuration, the ink from the nozzle 19A-1, which lands on the recording medium first, spreads on the recording medium at a high speed, and the ink from the nozzle 19B-1, which subsequently lands on the recording medium, has a large droplet. Accordingly, the streak generated in the coupling portion can be inconspicuous by complementing the portion where the ink that has landed first has not spread. In addition, since the nozzles 19A-2 (i.e., at least another part of the first coupling nozzles) and the nozzles 19A have the same diameter B, an image can easily be made uniform in the main scanning direction, the selection range of the droplets of the ink discharged first from the actuator unit 40A can be widened, and the adjustment of the droplets of the ink subsequently discharged from the actuator unit 40B can be greatly changed.

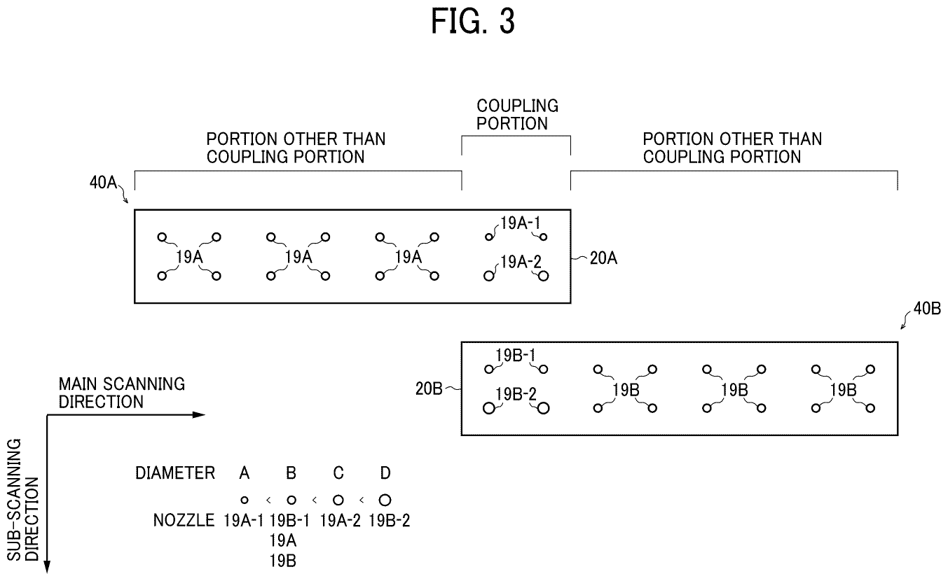

FIG. 3 illustrates a second embodiment of the present disclosure. The second embodiment is different from the first embodiment in that the diameters of the nozzle 19A-2 and the nozzle 19B-1 are changed to the diameter C and the diameter B, respectively.

With this configuration, effects similar to those of the first embodiment can be obtained. In addition, the actuator unit 40B, which subsequently discharges the ink, has the nozzles 19B-1 having the diameter B smaller than that of the nozzles 19A-2 of the actuator unit 40A, which discharge the ink first, to finely adjust the droplets of the ink, as compared with the first embodiment. In addition, since the nozzles 19B-1 (i.e., at least another part of the second coupling nozzles) and the nozzles 19B have the same diameter B, an image can easily be made uniform in the main scanning direction, the selection range of the droplets of the ink subsequently discharged from the actuator unit 40B can be widened, and the adjustment of the droplets of the ink discharged first from the actuator unit 40A can be greatly changed.

In the above-described embodiments, the nozzle holes of the actuator unit 40A, which discharges the ink first, and the actuator unit 40B, which subsequently discharges the ink, are parallel to the sub-scanning direction. In another actuator unit, nozzle holes may be inclined at a predetermined angle with respect to the sub-scanning direction.

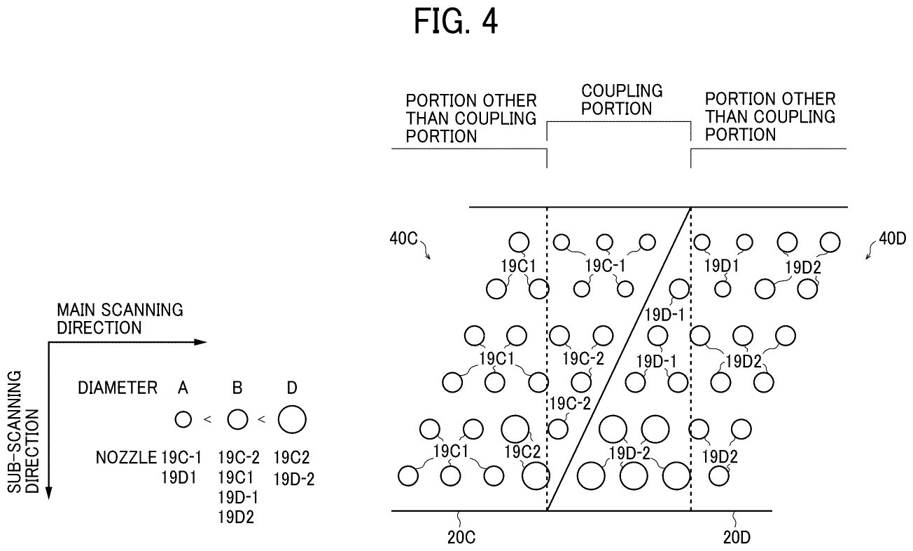

FIG. 4 illustrates a third embodiment of the present disclosure. The third embodiment is different from the above-described embodiments in that the nozzle holes are inclined at a predetermined angle with respect to the sub-scanning direction, and an actuator unit 40C, which discharges the ink first, and an actuator unit 40D, which subsequently discharges the ink, are arranged substantially in line in the main scanning direction.

The actuator unit 40C as a first actuator unit includes a nozzle substrate 20C as a first nozzle substrate on the bottom face, and the actuator unit 40D as a second actuator unit includes a nozzle substrate 20D as a second nozzle substrate on the bottom face. In FIG. 4, a portion where the respective actuator units 40C and 40D overlap each other is defined as a coupling portion.

Multiple nozzles are formed in the nozzle substrate 20C. Nozzles 19C-1 as first coupling nozzles are formed in the coupling portion. The nozzles 19C-1 have a diameter A. Nozzles 19C-2 as first coupling nozzles are also formed in the coupling portion. The nozzles 19C-2 have a diameter B. Nozzles 19C1 as first nozzles formed in a portion other than the coupling portion have the diameter B. Nozzles 19C2 as first nozzles have a diameter D.

Multiple nozzles are formed in the nozzle substrate 20D. Nozzles 19D-1 as second coupling nozzles are formed in the coupling portion. The nozzles 19D-1 have the diameter B. Nozzles 19D-2 as first coupling nozzles are also formed in the coupling portion. The nozzles 19D-2 have the diameter D. Nozzles 19D1 as second nozzles formed in a portion other than the coupling portion have the diameter A. Nozzles 19D2 as second nozzles have the diameter B.

With the above configuration, the nozzle substrate 20C has the nozzles 19C1 having the same diameter B as the nozzles 19C-2, and the nozzle substrate 20D has the nozzles 19D-1 and the nozzles 19D2 having the same diameter B as the nozzles 19C-2. In FIG. 4, when the nozzles formed in the upper half of the nozzle substrates 20C and 20D are focused, the ratio of the nozzles having small diameters is larger in the actuator unit 40C than in the actuator unit 40D.

With this configuration, the actuator unit 40D, which subsequently discharges the ink, has the nozzles 19D1 having the same small diameter A as that of the nozzles 19C-1 of the actuator unit 40C, which discharge the ink first. Accordingly, the effect of preventing the difference in image density can be maintained even when the discharge speed or the recording medium is changed.

In addition, the nozzle substrate 20D has the nozzles 19D2 having the same diameter B as the nozzles 19D-1, and the nozzle substrate 20C has the nozzles 19C-2 and the nozzles 19C1 having the same diameter B as the nozzles 19D-1. In FIG. 4, when the nozzles formed in the lower half of the nozzle substrates 20C and 20D are focused, the ratio of the nozzles having large diameters is smaller in the actuator unit 40C than in the actuator unit 40D.

With this configuration, the actuator unit 40D, which subsequently discharges the ink, has the nozzles 19D2 having the same large diameter B as that of the nozzles 19C-2 of the actuator unit 40C, which discharge the ink first. Accordingly, the effect of preventing the difference in image density can be maintained even when the discharge speed or the recording medium is changed.

In the first to third embodiments described above, the recording medium on which the ink lands is not considered, but the ink that lands on the recording medium wets and spreads on the recording medium differently depending on the wet spreadability of the ink inherent in each recording medium. Accordingly, a fourth embodiment will be described below, in which the wet spreadability of the ink on the recording medium is taken into consideration in the configuration of the first embodiment.

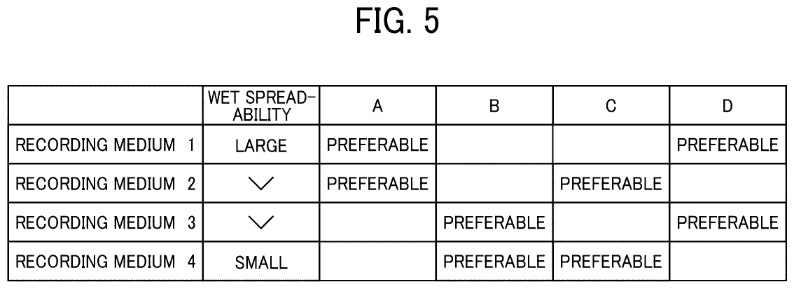

As illustrated in FIG. 5, in the fourth embodiment, four types of recording medium having different wet spreadabilities of ink are used. A recording medium 1 has the largest wet spreadability of ink. The ink is likely to permeate into the recording medium 1. The wet spreadability becomes smaller in the order of a recording medium 2, a recording medium 3, and a recording medium 4, and the ink is less likely to permeate into the recording medium 4.

With the above configuration, when the recording medium 1 having the largest wet spreadability is used, the area where the ink wets and spreads can be reduced by using the nozzle 19A-1 having the smallest diameter A, from which the ink is discharged first. Even if the ink wets and spreads on the recording medium 1, the ink can be superimposed on the ink that has wetted and spread on the recording medium 1 by using the nozzle 19B-2 having the largest diameter D, from which the ink is subsequently discharged. Accordingly, the streak generated in the coupling portion can be inconspicuous.

For the same reason, a combination of the nozzle 19A-1 having the diameter A and the nozzle 19B-1 having the diameter C is preferable for the recording medium 2, a combination of the nozzle 19A-2 having the diameter B and the nozzle 19B-2 having the diameter D is preferable for the recording medium 3, and a combination of the nozzle 19A-2 having the diameter B and the nozzle 19B-1 having the diameter C is preferable for the recording medium 4.

According to the fourth embodiment described above, the streak generated in the coupling portion can be inconspicuous in accordance with the wet spreadability of the ink on the recording medium.

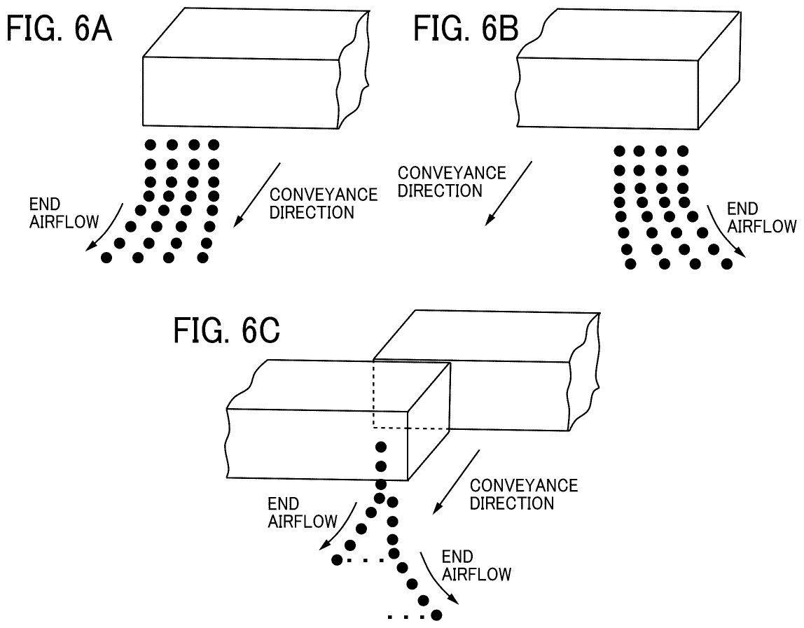

In each of the above-described embodiments, when two or more actuator units are coupled to each other, the nozzle diameter of the actuator unit, which subsequently discharges the ink in the coupling portion, is larger than the nozzle diameter of the actuator unit, which discharges the ink first in the coupling portion, and the nozzle diameter is selected based on the wet spreadability of the ink on the recording medium. However, when the ink lands on the recording medium, as illustrated in FIG. 6, end airflows may be generated at both ends of the coupling portion due to the influence of a discharge airflow generated when the ink is discharged or a conveyance airflow generated when the recording medium is conveyed. Accordingly, the discharged liquid may be bent, causing streaks or unevenness in an image corresponding to the coupling portion. In two actuator units coupled to each other, FIG. 6A illustrates an end airflow generated in one actuator unit, FIG. 6B illustrates an end airflow generated in the other actuator unit, and FIG. 6C illustrates end airflows generated in the outermost portions of the coupling portion of the actuator units. A configuration according to a fifth embodiment of the present disclosure will be described below to solve this situation.

In the fifth embodiment, an image defect due to the generation of the end airflow is prevented in the configuration of the first embodiment. The end airflows at the ends of the coupling portion in the main scanning direction are generated by the discharge airflow and the conveyance airflow as described above, and are greatly affected by the discharge airflow. The discharge airflow is affected by the conveyance speed of the recording medium. When the conveyance speed is lower than a predetermined speed, the discharge airflow increases, and thus the end airflow increases. When the conveyance speed is higher than the predetermined speed, the discharge airflow decreases, and thus the end airflow decreases.

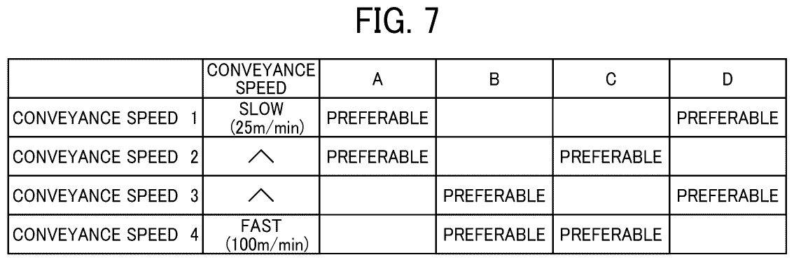

In the fifth embodiment, the difference between the diameters of the nozzle 19A-1 and the nozzle 19B-1 increases with a decrease in the conveyance speed of the recording medium. Specifically, as illustrated in FIG. 7, at the lowest conveyance speed 1 (25 m/min), the nozzle 19A-1 has the diameter A, and the nozzle 19B-1 has the diameter D. Then, as the conveyance speed increases from this conveyance speed, the difference between the diameters of the nozzle 19A-1 and the nozzle 19B-1 gradually decreases. At the highest conveyance speed (100 m/min), the nozzle 19A-1 has the diameter B, and the nozzle 19B-1 has the diameter C.

With this configuration, when the conveyance speed is low and the end airflow is large, the difference in diameters between the preceding droplet and the subsequent droplet is increased, and even when the position of the preceding droplet is shifted by the end airflow, the subsequent droplet having a large diameter covers the preceding droplet, so that a good image can be obtained.

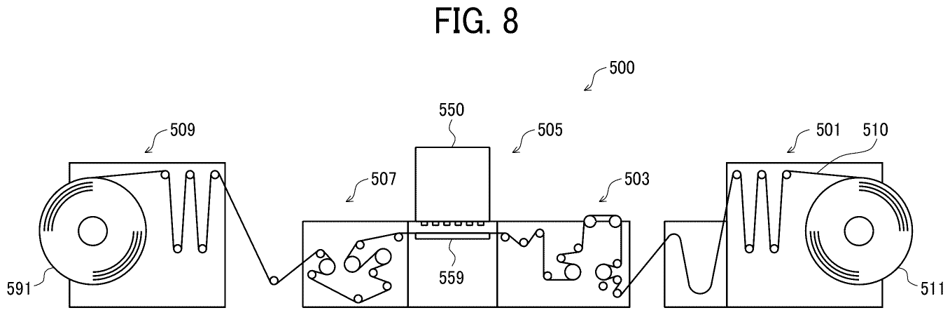

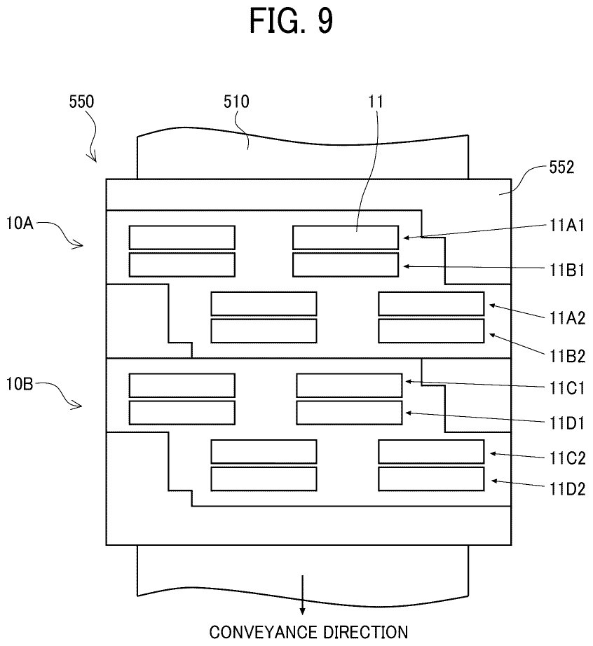

A description is given below of a liquid discharge apparatus including the liquid discharge head 11 described above. As illustrated in FIGS. 8 and 9, a printer 500 serving as the liquid discharge apparatus includes a feeder 501 to feed a continuous medium 510 as a recording medium, a guide conveyor 503 to guide and convey the continuous medium 510, fed from the feeder 501, to a printing unit 505. The printer 500 further includes the printing unit 505 to discharge a liquid onto the continuous medium 510 to form an image on the continuous medium 510, a dryer 507 to dry the continuous medium 510 to which the liquid adheres, and a carrier 509 to feed the dried continuous medium 510 outward.

The continuous medium 510 is fed from a winding roller 511 of the feeder 501, guided and conveyed with rollers of the feeder 501, the guide conveyor 503, the dryer 507, and the carrier 509, and wound around a take-up roller 591 of the carrier 509. These rollers serve as a conveyor to convey the continuous medium 510.

In the printing unit 505, the continuous medium 510 is conveyed on a conveyance guide 559 so as to face a head unit 550 as a liquid discharge unit. The head unit 550 discharges a liquid onto the continuous medium 510 to print an image.

The printer 500 includes liquid discharge units 10A and 10B, which are similar to the above-described liquid discharge unit 10, in the head unit 550. The liquid discharge units 10A and 10B are mounted on a common base 552.

The liquid discharge unit 10A includes head arrays 11A1, 11B1, 11A2, and 11B2. Each of the head arrays 11A1, 11B1, 11A2, and 11B2 includes liquid discharge heads 11 arranged in a head array direction perpendicular to a conveyance direction of the continuous medium 510. The liquid discharge unit 10B includes head arrays 11C1, 11D1, 11C2, and 11D2. Each of the head arrays 11C1, 11D1, 11C2, and 11D2 includes liquid discharge heads 11 arranged in the head array direction. The head arrays 11A1 and 11A2 of the liquid discharge unit 10A discharge liquid of the same color. Similarly, the head arrays 11B1 and 11B2 of the liquid discharge unit 10A are grouped as one set and discharge liquid of the same desired color. The head arrays 11C1 and 11C2 of the liquid discharge unit 10B are grouped as one set and discharge liquid of the same desired color. The head arrays 11D1 and 11D2 of the liquid discharge unit 10B are grouped as one set and discharge liquid of the same desired color.

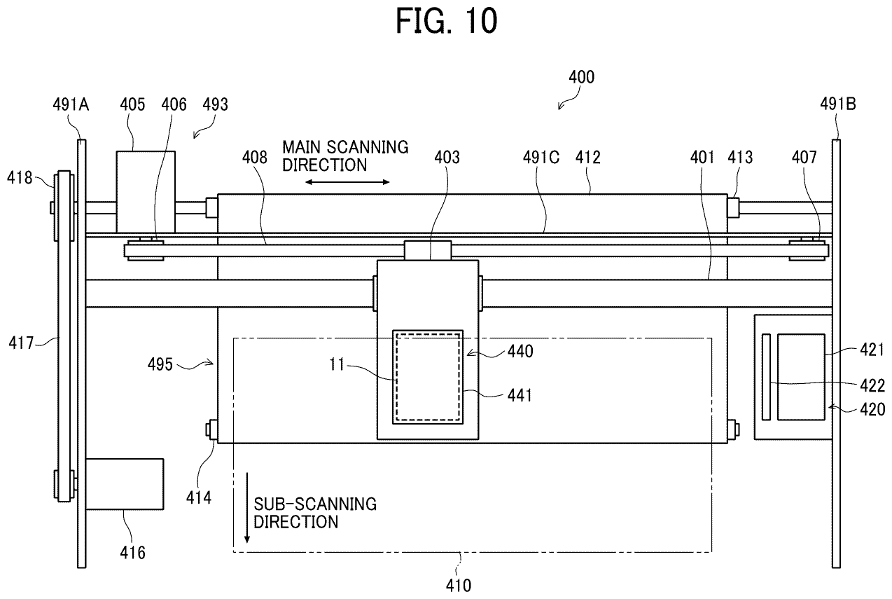

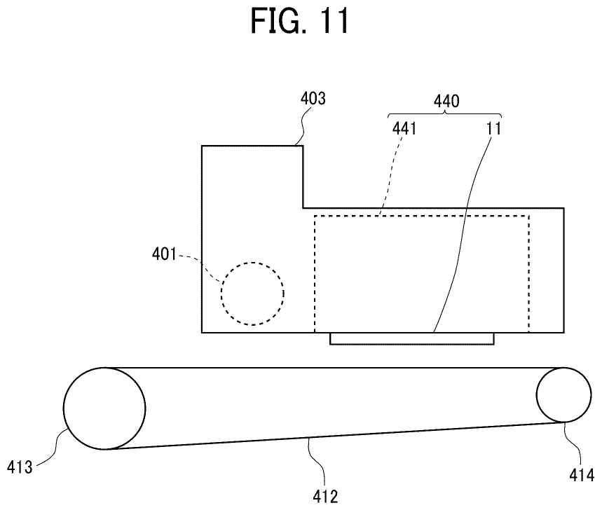

Another printer 400 as a liquid discharge apparatus is described below with reference to FIGS. 10 and 11. As the liquid discharge apparatus and an image forming apparatus, the printer 400 is a serial type printing apparatus, and a main-scanning moving mechanism 493 reciprocally moves a carriage 403 in the main scanning direction.

The main-scanning moving mechanism 493 includes a guide 401, a main scanning motor 405, and a timing belt 408. The guide 401 is bridged between left and right side plates 491A and 491B to movably hold the carriage 403. The carriage 403 is reciprocally moved in the main scanning direction by driving force of the main scanning motor 405 transmitted via the timing belt 408 looped around a drive pulley 406 and a driven pulley 407.

The carriage 403 mounts a liquid discharge unit 440 including the liquid discharge head 11 and a head tank 441 as a single integrated unit. The liquid discharge head 11 discharges color liquids of, for example, yellow (Y), cyan (C), magenta (M), and black (K). The liquid discharge head 11 is mounted on the liquid discharge unit 440 such that a nozzle row including the multiple nozzles is arranged in the sub-scanning direction perpendicular to the main scanning direction. The liquid discharge head 11 discharges the color liquid downward from the multiple nozzles. The liquid discharge head 11 is coupled to a liquid circulation device so that a liquid of a desired color is circulated and supplied to the liquid discharge head 11.

The printer 400 includes a conveyance mechanism 495 to convey a sheet 410 as the recording medium. The conveyance mechanism 495 includes a conveyance belt 412 as a conveyor and a sub-scanning motor 416 to drive the conveyance belt 412. The conveyance belt 412, which is an endless belt, is stretched between a conveyance roller 413 and a tension roller 414, and conveys the sheet 410 at a position facing the liquid discharge head 11 while attracting the sheet 410. The sheet 410 can be attracted to the conveyance belt 412 by, for example, electrostatic attraction or air suction. The conveyance belt 412 is circumferentially moved in the sub-scanning direction by driving force of the sub-scanning motor 416 transmitted via a timing belt 417 and a timing pulley 418.

On one end of the range of movement of the carriage 403 in the main scanning direction, a maintenance mechanism 420 that maintains and recovers the liquid discharge head 11 is disposed lateral to the conveyance belt 412. The maintenance mechanism 420 includes, for example, a cap 421 to cap a nozzle face (i.e., a face on which the multiple nozzles are formed) of the liquid discharge head 11 and a wiper 422 to wipe the nozzle face. The main-scanning moving mechanism 493, the maintenance mechanism 420, and the conveyance mechanism 495 are mounted onto a housing including the side plates 491A and 491B and a back plate 491C.

In the printer 400 having the above-described configuration, the sheet 410 is attracted on the conveyance belt 412 and conveyed in the sub-scanning direction by the circumferential movement of the conveyance belt 412. The liquid discharge head 11 is driven in response to an image signal while the carriage 403 moves in the main scanning direction to discharge a liquid onto the sheet 410 not in motion. As a result, an image is formed on the sheet 410.

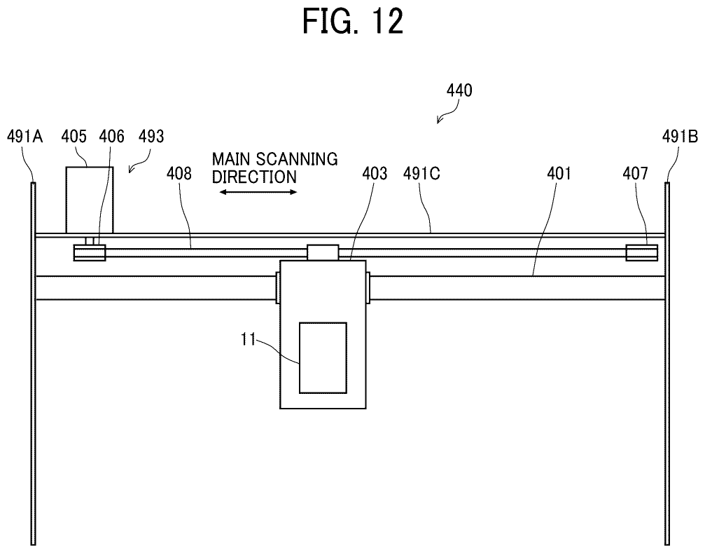

The above-described liquid discharge unit 440 is described below with reference to FIG. 12. The liquid discharge unit 440 includes the housing, the main-scanning moving mechanism 493, the carriage 403, and the liquid discharge head 11 among components of the printer 400 as the liquid discharge apparatus and the image forming apparatus. The side plates 491A and 491B, and the back plate 491C construct the housing. In the liquid discharge unit 440, the maintenance mechanism 420 described above may be mounted on, for example, the side plate 491B.

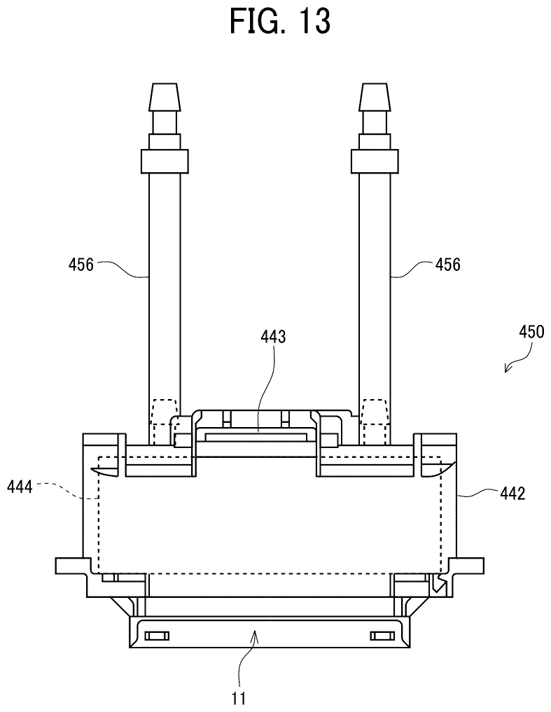

Another liquid discharge unit 450 is described below with reference to FIG. 13. The liquid discharge unit 450 illustrated in FIG. 13 includes the liquid discharge head 11 to which a channel component 444 is attached, and a tube 456 connected to the channel component 444. The channel component 444 is disposed inside a cover 442, and a connector 443 for electrically connecting to the liquid discharge head 11 is disposed on an upper portion of the channel component 444. In some embodiments, the liquid discharge unit 440 may include the head tank 441 instead of the channel component 444.

Each of the liquid discharge units 10, 10A, 10B, 440, 450, and 550 and each of the printers 400 and 500 as the liquid discharge apparatus, which includes the liquid discharge head 11 described above, can attain the same operational effects as the operational effects of the liquid discharge head 11 described above.

In the present disclosure, the liquid to be used is not limited to a particular liquid as long as the liquid has a viscosity or surface tension to be discharged from a head (liquid discharge head). However, preferably, the viscosity of the liquid is not greater than 30 millipascal-second (mPa·s) under ordinary temperature and ordinary pressure or by heating or cooling. Examples of the liquid include a solution, a suspension, or an emulsion that contains, for example, a solvent, such as water or an organic solvent; a colorant, such as dye or pigment; a functional material, such as a polymerizable compound, a resin, or a surfactant; a biocompatible material, such as deoxyribonucleic acid (DNA), amino acid, protein, or calcium; or an edible material, such as a natural colorant. Such a solution, a suspension, or an emulsion can be used for, e.g., inkjet ink, surface treatment solution, or a material solution for three-dimensional fabrication.

Examples of an energy source for generating energy to discharge liquid include a piezoelectric actuator (a laminated piezoelectric element or a thin-film piezoelectric element), a thermal actuator that employs a thermoelectric transducer, such as a thermal resistor, and an electrostatic actuator including a diaphragm and opposed electrodes.

The pressure generator used in the liquid discharge head is not limited to a particular type of pressure generator. In addition to the above-described piezoelectric actuator (which may use a laminated piezoelectric element), for example, a thermal actuator using a thermoelectric transducer such as a thermal resistor, and an electrostatic actuator including a diaphragm and opposed electrodes can be used.

The “liquid discharge unit” is an assembly of parts relating to liquid discharge. The term “liquid discharge unit” represents a structure including the liquid discharge head and a functional component(s) or mechanism(s) combined with the liquid discharge head as a single unit. For example, the “liquid discharge unit” includes a combination of the liquid discharge head with at least one of a head tank, a carriage, a supply mechanism, a maintenance mechanism, a main-scanning moving mechanism, or a liquid circulation device.

The above integration may be achieved by, for example, a combination in which the liquid discharge head and a functional part(s) are secured to each other through, e.g., fastening, bonding, or engaging, and a combination in which one of the liquid discharge head and a functional part(s) is movably held by another. The liquid discharge head may be detachably attached to the functional part(s) or mechanism(s).

The liquid discharge head and the head tank may be assembled, or the liquid discharge head and the head tank may be coupled (connected) to each other via, for example, a tube to form the liquid discharge unit as a single unit. A unit including a filter may further be added to a portion between the head tank and the liquid discharge head of the liquid discharge unit.

The liquid discharge unit may be an integrated unit in which the liquid discharge head and the carriage are integrated as a single unit, or the liquid discharge head, the carriage, and the main-scanning moving mechanism are integrated as a single unit. As yet another example, the liquid discharge unit is a unit in which the liquid discharge head and the scanning moving mechanism are combined into a single unit. The liquid discharge head is movably held by a guide that is a part of the scanning moving mechanism.

In another example, the cap that forms a part of the maintenance mechanism is fixed to the carriage mounting the liquid discharge head so that the liquid discharge head, the carriage, and the maintenance mechanism are integrated as a single unit to form the liquid discharge unit. Further, in another example, the liquid discharge unit includes a tube connected to the liquid discharge head mounting the head tank or the channel component so that the liquid discharge head and the supply mechanism are integrated as a single unit. Through the tube, the liquid in a liquid storage source is supplied to the liquid discharge head. The main-scanning moving mechanism may be a guide only. The supply mechanism may be a tube(s) only or a loading unit only.

Although the liquid discharge unit includes the liquid discharge head as described above, examples of the liquid discharge unit include a head module and the head unit including the above-described liquid discharge head, with which the above-described functional components or mechanisms are combined to form a single unit.

The liquid discharge apparatus used herein also represents a liquid discharge apparatus including the liquid discharge head, the liquid discharge unit, the head module, or the head unit to drive the liquid discharge head to discharge liquid. The liquid discharge apparatus used herein includes, in addition to apparatuses to discharge liquid to a medium onto which liquid can adhere, apparatuses to discharge the liquid into gas (air) or a different liquid.

The liquid discharge apparatus may further include devices relating to feeding, conveying, and ejecting of the medium onto which liquid can adhere and also include a pretreatment device and an aftertreatment device.

The liquid discharge apparatus may be, for example, an image forming apparatus to form an image on a recording medium by discharging ink, or a three-dimensional fabrication apparatus to discharge fabrication liquid to a powder layer in which powder material is formed in layers to form a three-dimensional object.

The liquid discharge apparatus is not limited to an apparatus that discharges liquid to visualize meaningful images such as letters or figures. For example, the liquid discharge apparatus may be an apparatus that forms patterns having no meaning or an apparatus that fabricates three-dimensional images.

The medium onto which liquid can adhere described above represents a medium onto which liquid is at least temporarily adhered, a medium onto which liquid is adhered and fixed, or a medium into which liquid adheres and permeates. Examples of the medium onto which liquid can adhere include recording medium, such as paper sheet, recording paper, recording sheet of paper, film, and cloth, electronic components, such as electronic substrate and piezoelectric element, and media, such as powder layer, organ model, and testing cell. The medium onto which liquid can adhere includes any medium to which liquid adheres, unless otherwise specified.

Examples of the material for the medium onto which liquid can adhere include any materials to which liquid can adhere even temporarily, such as paper, thread, fiber, fabric, leather, metal, plastic, glass, wood, and ceramic.

The liquid discharge apparatus moves the liquid discharge head and the medium onto which liquid can adhere relative to each other. Which of the liquid discharge head or the medium onto which liquid can adhere is moved is not limited. For example, the liquid discharge apparatus may be a serial head apparatus that moves the liquid discharge head or a line head apparatus that does not move the liquid discharge head.

Examples of the liquid discharge apparatus further include: a treatment liquid applying apparatus that discharges a treatment liquid onto a sheet to apply the treatment liquid to the surface of the sheet, for reforming the surface of the sheet; and an injection granulation apparatus that injects a composition liquid, in which a raw material is dispersed in a solution, through a nozzle to granulate fine particles of the raw material.

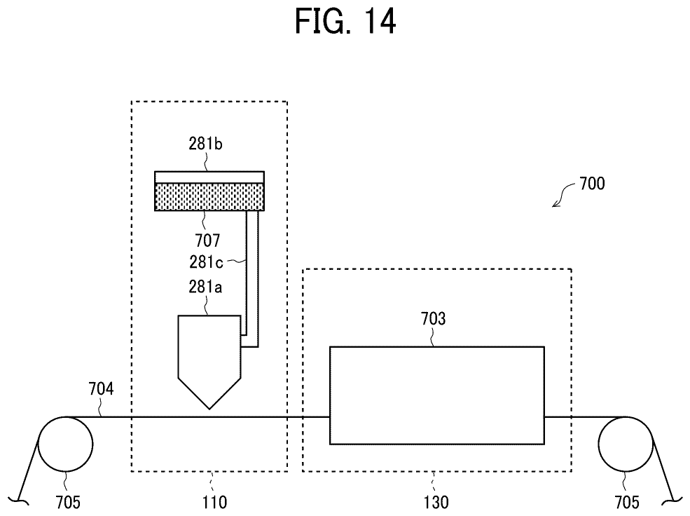

The liquid discharge apparatus may also include an apparatus for manufacturing an electrode and an electrochemical element, which is also referred to as an electrode manufacturing apparatus. The electrode manufacturing apparatus is described below. FIG. 14 is a schematic view of an electrode manufacturing apparatus. An electrode manufacturing apparatus 700 is an apparatus for manufacturing an electrode including a layer containing an electrode material by discharging a liquid composition using a liquid discharge unit including a liquid discharge head. A description is given below of a device and process for forming a layer containing an electrode material.

The liquid discharge device in the electrode manufacturing apparatus 700 illustrated in FIG. 14 is the liquid discharge unit described above. The liquid discharge head of the liquid discharge unit discharges a liquid composition. By so doing, the liquid composition is applied onto an object, and a liquid composition layer is formed on the object. The object, which may also be referred to as a discharge target in the following description, is not limited to any particular object and may be appropriately selected depending on the intended purpose, as long as the object is an object on which a layer containing an electrode material is to be formed. Examples of the object include an electrode substrate, i.e., a current collector, an active material layer, and a layer containing a solid electrode material. The object may be an electrode composite layer containing an active material on an electrode substrate. A discharge device (e.g., a discharge process device 110) and a discharge process may be a device and a process of forming a layer containing an electrode material by directly discharging a liquid composition as long as the layer containing an electrode material can be formed on a discharge target. The discharge device and the discharge process may be a device and a process of forming a layer containing an electrode material by indirectly discharging a liquid composition.

Other configurations and processes are described below. Other configurations included in the electrode manufacturing apparatus for manufacturing an electrode composite layer are not limited to any particular configuration and may be appropriately selected depending on the intended purpose, as long as the effects of the present embodiment are not impaired. Other processes included in the method for manufacturing an electrode composite layer are not limited to any particular process and may be appropriately selected depending on the intended purpose, as long as the effects of the present embodiment are not impaired. For example, a heating device and a heating process are examples of the configuration and the process included in the electrode manufacturing apparatus and the manufacturing method of the electrode composite layer.

The heating device and the heating process are described below. The heating device (e.g., a heating process device 130) included the electrode manufacturing apparatus for manufacturing an electrode composite layer is a device that heats the liquid composition discharged by the discharge device. The heating process included in the manufacturing method for manufacturing an electrode composite layer is a process of heating the liquid composition discharged in the discharge process. The liquid composition is heated to dry the liquid composition layer.

A description is given below of a structure to form a layer containing an electrode material by directly discharging a liquid composition. An electrode manufacturing apparatus, which forms a layer containing an electrode material, is described below. The electrode manufacturing apparatus forms an electrode composite layer containing an active material on an electrode substrate (current collector).

As illustrated in FIG. 14, the electrode manufacturing apparatus 700 includes the discharge process device 110 and the heating process device 130. The discharge process device 110 performs a discharge process of applying a liquid composition onto a print base material 704 having a discharge target to form a liquid composition layer. The heating process device 130 performs a heating process of heating the liquid composition to obtain an electrode composite layer.

The electrode manufacturing apparatus 700 further includes a conveyance unit 705 that conveys the print base material 704. The conveyance unit 705 conveys the print base material 704 to the discharge process device 110 and the heating process device 130 in this order at a preset speed. A method of producing the print base material 704 having the discharge target such as an active material layer is not limited to any particular method, and a known method can be appropriately selected. The discharge process device 110 includes a liquid discharge head 281a that performs an application process of applying the liquid composition onto the print base material 704, a storage container 281b that stores a liquid composition 707, and a supply tube 281c that supplies the liquid composition 707 in the storage container 281b to the liquid discharge head 281a.

The discharge process device 110 discharges the liquid composition 707 from the liquid discharge head 281a so that the liquid composition 707 is applied onto the print base material 704 to form a liquid composition layer in a thin film shape. The storage container 281b may be integrated with the electrode manufacturing apparatus that forms the electrode composite layer or may be detachable from the electrode manufacturing apparatus. The storage container 281b may be a container additionally attachable to a container integrated with the electrode manufacturing apparatus for manufacturing the electrode composite layer or to a container detachable from the electrode manufacturing apparatus for manufacturing the electrode composite layer. The storage container 281b that stably stores the liquid composition 707 and the supply tube 281c that stably supplies the liquid composition 707 can be used.

The heating process device 130 performs a solvent removal process of heating and removing the solvent remaining in the liquid composition layer. Specifically, the solvent that remains in the liquid composition layer is heated and dried by a heater 703 of the heating process device 130 to remove the solvent from the liquid composition layer. Accordingly, the electrode composite layer is formed. The heating process device 130 may perform the solvent removal process under reduced pressure.

The heater 703 is not limited to any particular heater and may be appropriately selected depending on the intended purpose. For example, the heater 703 may be a substrate heater, an infrared (IR) heater, or a hot air heater. The heater 703 may be a combination of at least two of the substrate heater, the IR heater, and the hot air heater. A heating temperature and heating time can be appropriately selected according to the boiling point of the solvent contained in the liquid composition 707 or the thickness of a formed film.

In the electrode manufacturing apparatus 700, a liquid discharge head similar to the liquid discharge head 11 described above is used as the liquid discharge head 281a. The electrode manufacturing apparatus 700 is used to discharge the liquid composition to a desired position on the discharge target. The electrode composite layer can be suitably used, for example, as a part of the configuration of an electrochemical element. The configuration of the electrochemical element other than the electrode composite layer is not limited to any particular configuration, and a known configuration can be appropriately selected. Examples of the configuration other than the electrode composite layer include a positive electrode, a negative electrode, and a separator.

Aspects of the present disclosure are, for example, as follows.

### ASPECT 1

A liquid discharge head includes a first actuator unit and a second actuator unit. The first actuator unit includes a first nozzle substrate in which multiple nozzles are formed to discharge a liquid from the nozzles. The second actuator unit includes a second nozzle substrate in which multiple nozzles are formed to discharge a liquid from the nozzles. The liquid discharge head has a coupling portion where the first actuator unit and the second actuator unit are coupled. First coupling portion nozzles corresponding to the coupling portion and first nozzles corresponding to a portion other than the coupling portion are formed as the multiple nozzles in the first nozzle substrate. Second coupling portion nozzles corresponding to the coupling portion and second nozzles corresponding to a portion other than the coupling portion are formed as the multiple nozzles in the second nozzle substrate. After the liquid is discharged from the first nozzle substrate to the recording medium, the liquid is discharged from the second nozzle substrate to the recording medium. The liquid discharged from the second coupling portion nozzles is superimposed on the liquid discharged from the first coupling portion nozzles and lands on the recording medium in the coupling portion. A diameter of the second coupling portion nozzle is larger than a diameter of the first coupling portion nozzle.

In other words, a liquid discharge head includes a first actuator unit and a second actuator unit. The first actuator unit includes a first nozzle substrate arranged in a first direction. The second actuator unit includes a second nozzle substrate arranged in the first direction. The first nozzle substrate has first nozzles and first overlapping nozzles. The first nozzles are disposed in a first main portion of the first actuator unit. Each of the first nozzles has a first diameter. The first overlapping nozzles are disposed in a first overlapping portion of the first actuator unit other than the first main portion. At least part of the first overlapping nozzles has a first overlapping diameter smaller than the first diameter. The second nozzle substrate has second nozzles and second overlapping nozzles. The second nozzles are disposed in a second main portion of the second actuator unit. Each of the second nozzles has a second diameter. The second overlapping nozzles are disposed in a second overlapping portion of the second actuator unit other than the second main portion. The second overlapping portion is overlapped with the first overlapping portion in a second direction orthogonal to the first direction. At least part of the second overlapping nozzles having a second overlapping diameter larger than the first overlapping diameter.

### ASPECT 2

In the liquid discharge head according to Aspect 1, a diameter of the first coupling portion nozzle is equal to a diameter of the first nozzle.

In other words, another of said at least part of the first overlapping nozzles has the first diameter.

### ASPECT 3

In the liquid discharge head according to Aspect 1 or 2, a diameter of the second coupling portion nozzle is equal to a diameter of the second nozzle.

In other words, another of said at least part of the second overlapping nozzles has the second diameter.

### ASPECT 4

In the liquid discharge head according to Aspect 1, the first nozzle is formed on the first nozzle substrate with the same diameter as the first coupling portion nozzle, and the second coupling portion nozzle and/or the second nozzle are formed on the second nozzle substrate with the same diameter as the first coupling portion nozzle.

In other words, another of said at least part of the first overlapping nozzles has the first diameter. Another of said at least part of the second overlapping nozzles has a third

### ASPECT 5

In the liquid discharge head according to Aspect 1, the second nozzle is formed on the second nozzle substrate with the same diameter as the second coupling portion nozzle, and the first coupling portion nozzle and/or the first nozzle are formed on the first nozzle substrate with the same diameter as the second coupling portion nozzle.

In other words, another of said at least part of the second overlapping nozzles has the second diameter. Another of said at least part of the first overlapping nozzles has a fourth overlapping diameter larger than the second diameter and smaller than the second overlapping diameter. The second nozzles have the second diameter same as the first diameter of the first nozzles.

Alternatively, another of said at least part of the first overlapping nozzles has the first diameter. Another of said at least part of the second overlapping nozzles has the second diameter. The second nozzles have the second diameter same as the first diameter of the first nozzles.

### ASPECT 6

In the liquid discharge head according to Aspect 1, as the conveyance speed of the recording medium decreases, the difference between the diameter of the first coupling portion nozzle and the diameter of the second coupling portion nozzle is increased.

In other words, in the liquid discharge apparatus according to Aspect 8, the second actuator unit has the second overlapping nozzles having the second overlapping diameter larger than the first overlapping diameter with a difference, and the difference is increased

### ASPECT 7

A liquid discharge unit includes the liquid discharge head according to any one of Aspects 1 to 6.

In other words, a liquid discharge unit includes the liquid discharge head according to any one of Aspects 1 to 6 and a carriage mounting the liquid discharge head to move the liquid discharge head in the second direction.

### ASPECT 8

A liquid discharge apparatus includes the liquid discharge head according to any one of Aspects 1 to 6.

In other words, a liquid discharge apparatus includes the liquid discharge head according to any one of Aspects 1 to 6, a conveyor to convey a medium to the liquid discharge head in the second direction, and circuitry to control the first actuator unit and the second actuator unit to discharge the liquid onto the medium to form dots of the liquid on the medium. The first actuator unit is disposed upstream from the second actuator unit in the second direction. The circuitry controls the first actuator unit to discharge the liquid onto the medium to form first dots of the dots on the medium and controls the second actuator unit to discharge the liquid onto the medium to form second dots of the dots on the medium to superimpose the second dots on the first dots.

### ASPECT 9

A liquid discharge apparatus includes the liquid discharge unit according to Aspect 7.

In other words, a liquid discharge apparatus includes the liquid discharge unit according to Aspect 7 and a conveyor to convey the medium to the liquid discharge unit.

According to one aspect of the present disclosure, a liquid discharge head can be provided that makes a streak generated in a coupling portion inconspicuous by complementing a portion where ink landed first on a recording medium does not sufficiently spread on the recording medium with ink subsequently landed on the recording medium.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A liquid discharge head comprising:
a first actuator unit including a first nozzle substrate arranged in a first direction; and
a second actuator unit including a second nozzle substrate arranged in the first direction,
wherein the first nozzle substrate has:
first nozzles in a first main portion of the first actuator unit, each of the first nozzles having a first diameter; and
first overlapping nozzles in a first overlapping portion of the first actuator unit other than the first main portion,
at least part of the first overlapping nozzles having a first overlapping diameter smaller than the first diameter, and
the second nozzle substrate has:
second nozzles in a second main portion of the second actuator unit, each of the second nozzles having a second diameter; and
second overlapping nozzles in a second overlapping portion of the second actuator unit other than the second main portion,
the second overlapping portion overlapped with the first overlapping portion in a second direction orthogonal to the first direction, and
at least part of the second overlapping nozzles having a second overlapping diameter larger than the first overlapping diameter.

2. The liquid discharge head according to claim 1,
wherein another of said at least part of the first overlapping nozzles has the first diameter.

3. The liquid discharge head according to claim 1,
wherein another of said at least part of the second overlapping nozzles has the second diameter.

4. The liquid discharge head according to claim 1,
wherein another of said at least part of the first overlapping nozzles has the first diameter,
another of said at least part of the second overlapping nozzles has a third overlapping diameter larger than the second overlapping diameter, and
the second nozzles have the second diameter same as the first diameter of the first nozzles.

5. The liquid discharge head according to claim 1,
wherein another of said at least part of the second overlapping nozzles has the second diameter,
another of said at least part of the first overlapping nozzles has a fourth overlapping diameter larger than the second diameter and smaller than the second overlapping diameter, and
the second nozzles have the second diameter same as the first diameter of the first nozzles.

6. The liquid discharge head according to claim 1,
wherein another of said at least part of the first overlapping nozzles has the first diameter,
another of said at least part of the second overlapping nozzles has the second diameter, and
the second nozzles have the second diameter same as the first diameter of the first nozzles.

7. A liquid discharge unit comprising:
the liquid discharge head according to claim 1; and
a carriage mounting the liquid discharge head to move the liquid discharge head in the second direction.

8. A liquid discharge apparatus comprising:
the liquid discharge head according to claim 1;
a conveyor to convey a medium to the liquid discharge head in the second direction; and
circuitry configured to control the first actuator unit and the second actuator unit to discharge the liquid onto the medium to form dots of the liquid on the medium,
wherein the first actuator unit is disposed upstream from the second actuator unit in the second direction, and
the circuitry is further configured to:
control the first actuator unit to discharge the liquid onto the medium to form first dots of the dots on the medium, and
control the second actuator unit to discharge the liquid onto the medium to form second dots of the dots on the medium to superimpose the second dots on the first dots.

9. A liquid discharge apparatus comprising:
the liquid discharge unit according to claim 7; and
a conveyor to convey the medium to the liquid discharge unit.

10. The liquid discharge apparatus according to claim 8,
wherein the second actuator unit has the second overlapping nozzles having the second overlapping diameter larger than the first overlapping diameter with a difference, and
the difference is increased with a decrease in a conveyance speed of the conveyor.
